(19) United States
(12) Patent Application Publication
(10) Pub. No.: US 2026/0064816 A1
(43) Pub. Date: Mar. 5, 2026

(54) SPATIAL COMPUTING SOURCE CODE DEVELOPMENT SECURITY SYSTEM

(71) Applicant: Bank of America Corporation, Charlotte, NC (US)

(72) Inventors: Shailendra Singh, Maharashtra (IN); Souravmoy Gorai, Durgapur (IN); Hari Hara Suthan Theenathayalan, Tamil Nadu (IN); Satya Murthy Yenamandra, Hyderabad Andhra Pradesh (IN)

(21) Appl. No.: 18/820,413

(22) Filed: Aug. 30, 2024

(51) Int. Cl. G06F 21/32; G06F 8/77

(52) U.S. Cl. CPC G06F 21/32; G06F 8/77

(57) ABSTRACT

Methods for securing a spatial computing distributed development and deployment environment are provided. Methods may include identifying, by a first developer operating a first spatial computing device, the presence of one or more other developers operating one or more other spatial computing devices within a field of view of the first developer. Methods may also include extracting, by the first spatial computing device, biometric data from each of the one or more other developers. Methods may also include determining, by the first spatial computing device, an identity of the one or more developers by comparing the extracted biometric data to stored biometric data within a biometric database. Methods may also include retrieving, by the first spatial computing device, one or more source code tokens created by the one or more developers. Methods may also include rendering, at the first spatial computing device, the retrieved one or more source code tokens.

### FIELD OF TECHNOLOGY

Aspects of the disclosure relate to computer code security.

### BACKGROUND OF THE DISCLOSURE

Distributed programming teams may be located at various geographic locations. Such teams typically include software developers. Such developers may operate in different environments. The environments may involve one developer. The environments may involve multiple developers.

Although the developers may operate in different environments, the developers within the distributed programming teams may work on the same code base. Having distributed programming teams operate in different environments may create security issues. For example, it may be difficult to control production environment code from being overwritten by unidentified code. Such overwrites may lead to an unstable production environment. In addition, distributed programming environments may risk the injection of malicious code into the production code environment. Such malicious code may result in a compromised production environment.

Therefore, it may be desirable to create a security system for a distributed programing environment. Such a security system may enable developers to securely develop code and securely commit the code to a database or production environment. Such a security system may enable the developers to develop the code using one or more spatial computing devices. The code may be software code, source code or any other suitable code.

### SUMMARY OF THE DISCLOSURE

A security system for a distributed programming environment involving spatial computing devices is provided.

Spatial computing involves human-computer interaction techniques that are perceived by users as taking place in the real world, in and around their natural bodies and physical environments, instead of constrained to and perceptually behind computer screens. Spatial computing may invert the long-standing practice of teaching people to interact with computers in digital environment, and instead teaches computers to better understand and interact with people more naturally in the human world. This concept extends to extended reality, augmented reality, mixed reality, natural user interface, contextual computing, affective computing and ubiquitous computing. Examples of spatial computing devices may include smartglasses, virtual reality glasses or augmented reality glasses.

Spatial computing may allow a user to define points in a space. The space may be a virtual space. The space may be a physical space. The space may be referred to as a geolocation. Points on the space may be referred to as geocoordinates. Spatial computing enables a user to manipulate and perform one or more computations on the points or geocoordinates.

Such a security system may include a code identification system. The code identification system may include methods for identifying the user of the spatial computing device. The code identification system may be used to ensure that the code provided by the user has been properly assigned to an identified and authenticated developer. The security system may ensure that the developer is an authenticated developer within the distributed spatial computing development environment.

The security system may compare the code or code snippet between the lower environment and the higher environment. The security system may check if malicious code has been injected in between the transition of the lower environment, such as the development environment and the higher environment, such as the production environment.

A code snippet may be defined as a code segment that is reusable. The code segment may be small. The code segment may be large. One disadvantage associated with code segments may be that a developer using a code segment may not be aware of injection attacks included within the code segments. Another disadvantage may be that a developer using the code segment may not be aware of hard-coded credentials that may be required to be input into the system in order to ensure the correct functioning of the system. Yet another disadvantage may be that a developer using a code segment may not be aware that the code snippet is dependent on one or more other programs. As such, an actual developer may review the code snippet and determine whether or not the code snippet should be added to a code base.

The security system may include an artificial intelligence (“AI”) component. The AI component may understand what components should be included in healthy development environment code and production environment code. The security system may enable a developer to scan the source code or code snippet using one or more spatial computing devices. The scan may identify code overwrites and/or malicious code.

The security system may allow the developer to extract facial biometric data of a second developer using a spatial computing device. Using the spatial computing device, the developer may view and/or acquire one or more source code elements linked to the second developer. The source code elements linked to the second developer may be displayed in spatial interface pallets and/or manipulated using one or more gestures.

The security system may enable the developer to extract one or more source code elements of one or more developers using a spatial computing device. The security system may enable the developer to link multiple source code elements. The security system may enable the developer to manipulate the code repository of multiple developers using one or more gestures. The security system may enable the developer to annotate/highlight source code elements/sections/components which are similar.

The security system may identify a style of a developer. The style may be used to validate a source code element. The security system may annotate code segments that are identified to be suspicious.

The security system may enable a developer to use a spatial computing device to automatically merge, in a secure and non-redundant manner, source code created by multiple developers. Compiled code may be validated on a spatial computing device network. Validated code may be ensured that it complies with a set of smart contract predefined rules. Upon identification of compliance, validated code may be pushed to a production environment.

The security system may create identity tokens for source code segments. The identity tokens may identify a developer using one or more biometric elements and/or a personalized style. A source code repository may include one or more identity tokens. The identity tokes may be used to validate and authorize a source code repository. An identity token may be utilized to trigger one or more tasks for future development.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6A shows illustrative computer code in accordance with principles of the disclosure;

FIG. 6B shows an illustrative diagram in accordance with principles of the disclosure; and

FIG. 7 shows an illustrative flow chart in accordance with principles of the disclosure.

### DETAILED DESCRIPTION OF THE DISCLOSURE

Systems, apparatus and methods for securing a spatial computing distributed development and deployment environment is provided. Methods may include identifying, by a first developer operating a first spatial computing device, the presence of one or more other developers operating one or more other spatial computing devices within a field of view of the first developer within the environment.

Methods may also include extracting, by the first spatial computing device, biometric data from each of the one or more other developers. Methods may also include determining, by the first spatial computing device, an identity of the one or more developers by comparing the extracted biometric data to stored biometric data within a biometric database.

Methods may also include retrieving, by the first spatial computing device, one or more source code tokens created by the one or more developers. Methods may also include rendering, at the first spatial computing device, the retrieved one or more source code tokens.

Methods may include manipulating, at the first spatial computing device, the one or more source code tokens. The manipulating may be executed by receiving one or more gestures from the first developer via the first spatial computing device.

Methods may include detecting, at the first spatial computing device, anomalies within the one or more source code tokens. Methods may include quarantining the one more source code tokens that include anomalies. Methods may also include preventing deploying of the quarantined source code tokens.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

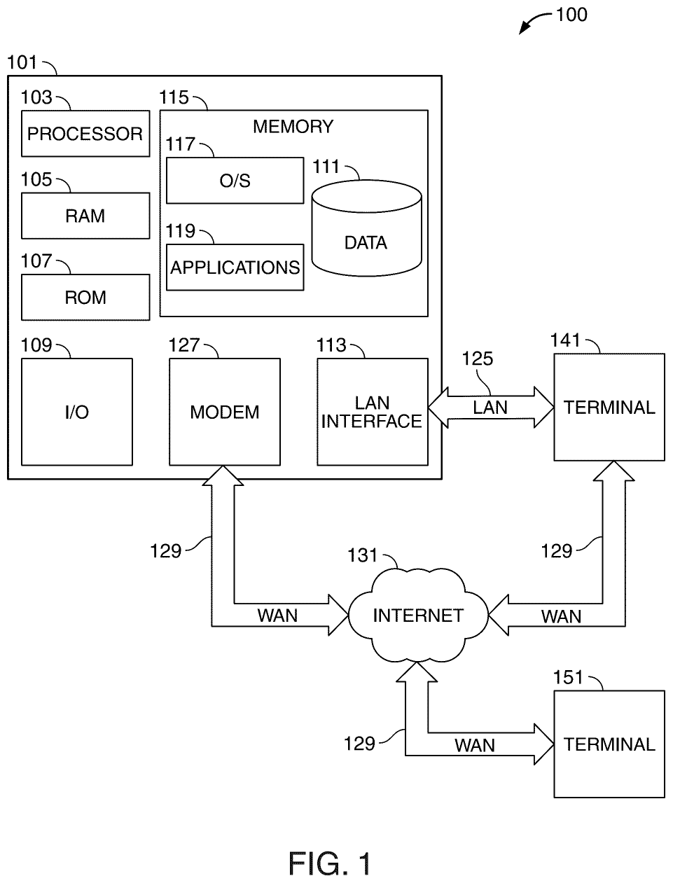

FIG. 1 shows an illustrative block diagram of system 100 that includes computer 101. Computer 101 may alternatively be referred to herein as an “engine,” “server,” or a “computing device. ” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

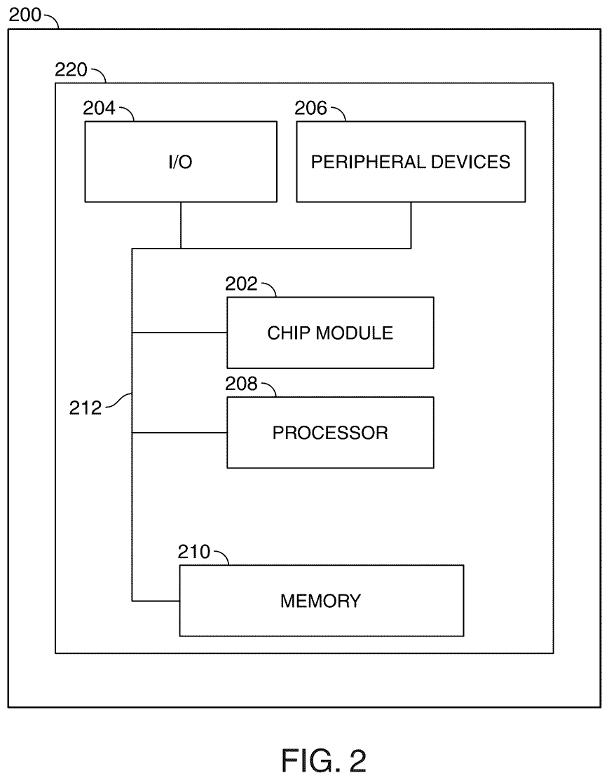

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

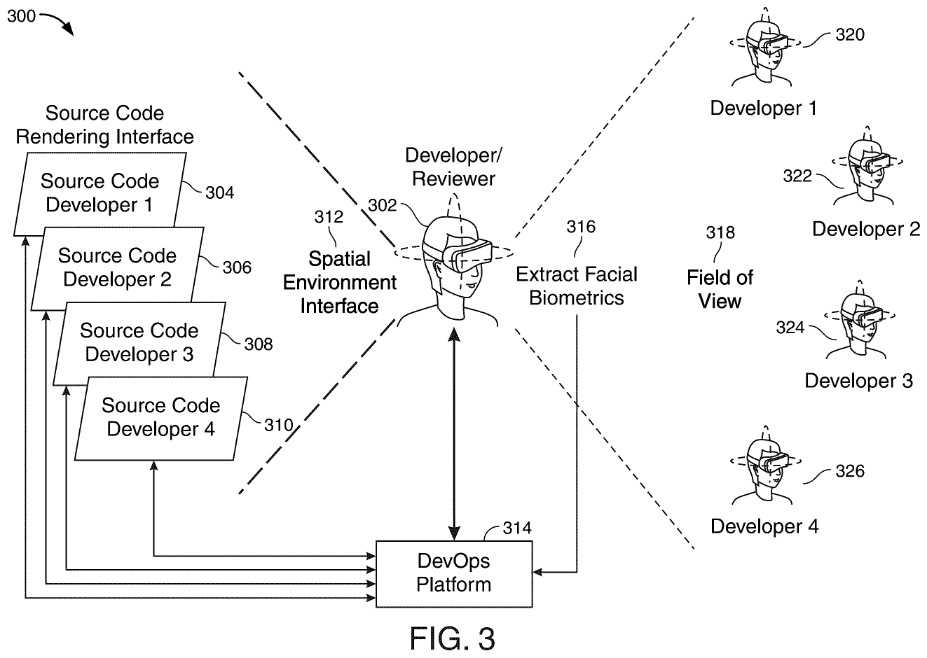

FIG. 3 shows an illustrative diagram 300. Illustrative diagram 300 shows a developer/reviewer 302 operating within DevOps (Development Operations) Platform 314. Developer/reviewer 302 may utilize one or more spatial computing devices to interact with spatial environment interface 312.

Spatial environment interface 312 may include a source code rendering interface. The source code rendering interface may be an interface that enables viewing of one or more computer code elements. The source code rendering interface may also enable viewing of an author of each computer code element. The computer code element may be a source code element. The author of the computer code element may be a developer. The developer may be developer 302. The developer may be any other suitable developer.

The source code rendering interface may display source code created by a developer within a field of view of developer 302. Initially, developer/reviewer 302, using a spatial computing device, may locate another developer, such as developer 1, shown at 320. Developer/reviewer 302, using the spatial computing device in communication with DevOps platform 314, may extract, as shown at 316, the facial biometrics of developer 1. Upon extracting the facial biometrics of developer 1, DevOps platform 314 may retrieve source code files created by developer 1. Source code rendering interface, operating within spatial environment interface 312, may display, to developer/reviewer 302, source code file 1 created by developer 1, shown at 304.

Developer/reviewer 302, using a spatial computing device, may locate a second developer, such as developer 2, shown at 322. Developer/reviewer 302, using the spatial computing device in communication with DevOps platform 314, may extract, as shown at 316, the facial biometrics of developer 2. Upon extracting the facial biometrics of developer 2, DevOps platform 314 may retrieve source code files created by developer 2. Source code rendering interface, operating within spatial environment interface 312, may display, to developer/reviewer 302, source code file 2 created by developer 2, shown at 306.

Developer/reviewer 302, using a spatial computing device, may locate a third developer, such as developer 3, shown at 324. Developer/reviewer 302, using the spatial computing device in communication with DevOps platform 314, may extract, as shown at 316, the facial biometrics of developer 3. Upon extracting the facial biometrics of developer 3, DevOps platform 314 may retrieve source code files created by developer 3. Source code rendering interface, operating within spatial environment interface 312, may display, to developer/reviewer 302, source code file 3 created by developer 3, shown at 308.

Developer/reviewer 302, using a spatial computing device, may locate a fourth developer, such as developer 4, shown at 326. Developer/reviewer 302, using the spatial computing device in communication with DevOps platform 314, may extract, as shown at 316, the facial biometrics of developer 4. Upon extracting the facial biometrics of developer 4, DevOps platform 314 may retrieve source code files created by developer 4. Source code rendering interface, operating within spatial environment interface 312, may display, to developer/reviewer 302, source code file 4 created by developer 4, shown at 310.

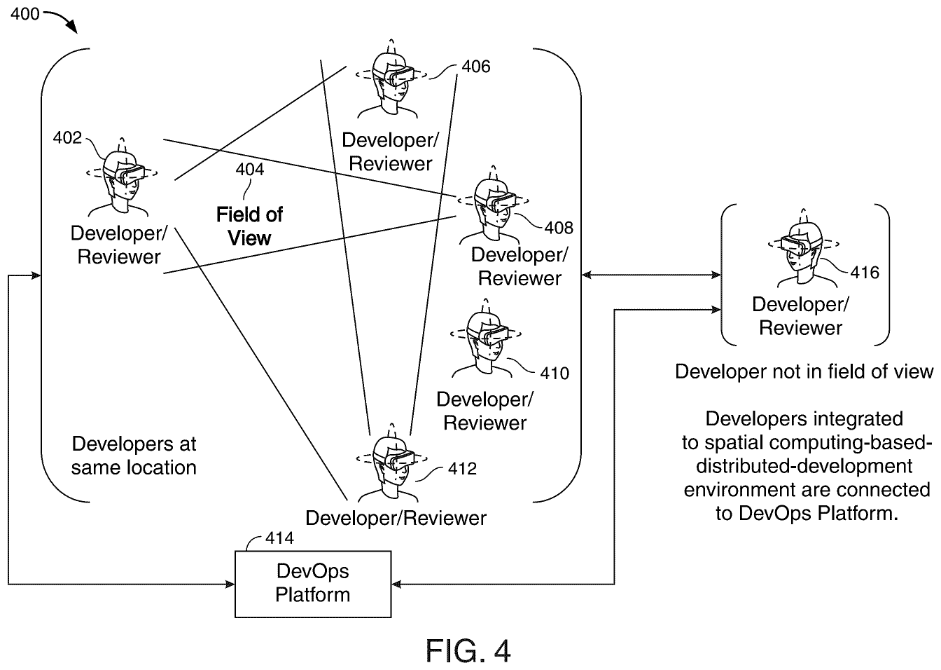

FIG. 4 shows an illustrative diagram 400. Illustrative diagram 400 shows DevOps platform 414. At DevOps platform 414, multiple developers/reviewers may be located. Each of the developers/reviewers may develop code, review code or otherwise operate within DevOps platform 414. Some of the developers/reviewers may be located at the same location. As such, developer/reviewer 402, developer/reviewer 406, developer/reviewer 408, developer/reviewer 410, developer/reviewer 412 may be located at the same location. Each of developers/reviewers 402, 406, 408, 410 and 412 may be able to view each other using one or more spatial computing devices. As shown at 404, developer/reviewer 402 may be in the field of view of developer/reviewer 408. Developer/reviewer 408 may be in the field of view of developer/reviewer 402.

Developer/reviewer 416 may be located at a different location from developer/reviewers 402, 406, 408, 410 and 412. Developer/reviewer 416 may be located at the same location as developer/reviewers 402, 406, 408, 410 and 412. Developer/reviewer 416 may not be in the field of view of other developers/reviewers. However, it should be noted that developer/reviewer 416 may be able to use a spatial computing device to turn on the capability to view and/or be viewable by other developers.

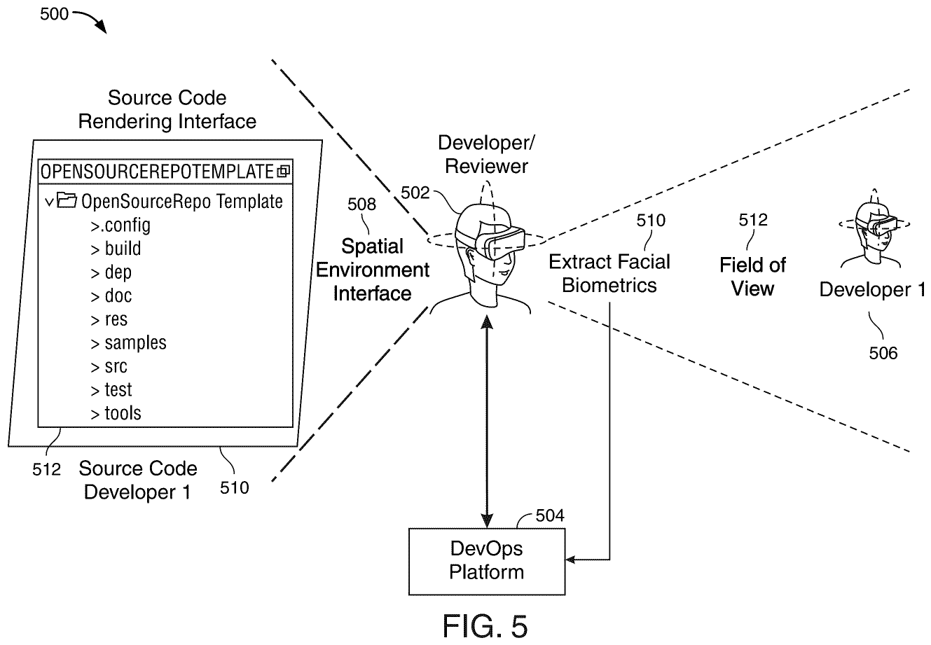

FIG. 5 shows an illustrative diagram 500. Illustrative diagram 500 shows developer/reviewer 502 operating within DevOps platform 504. Operating within DevOps platform 504, developer/reviewer 502 may locate developer 1, shown at 506, within field of view 512. Upon viewing developer 1 within field of view 512, developer/reviewer 502 may extract facial biometrics, as shown at 510, from developer 1.

Upon extracting facial biometrics from developer 1, DevOps platform 504 may retrieve source code created by developer 1. Such source code may be displayed on spatial environment interface 508 provided by DevOps platform 504. Developer/reviewer 502 may review the source code created by developer 1 using spatial environment interface 508. Spatial environment interface 508 may include source code rendering interface 510. Source code rendering interface 510 may display source code created by developer 1, as shown at 512.

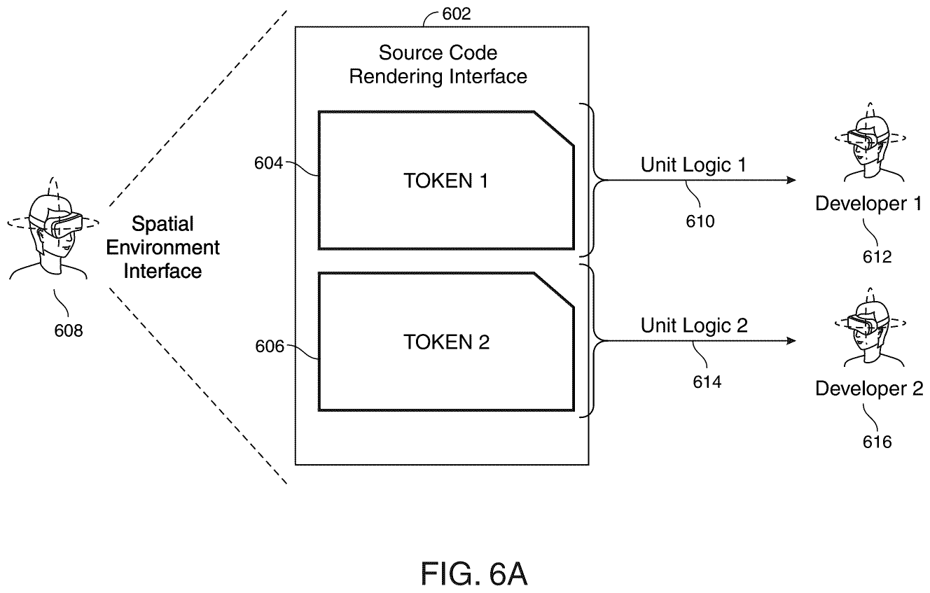

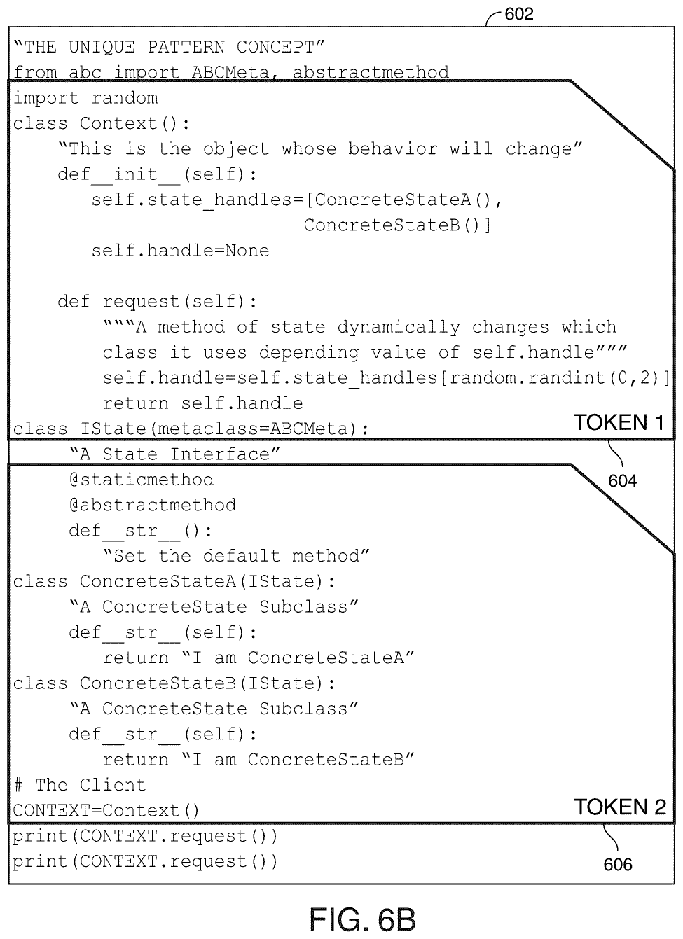

FIGS. 6A and 6B show an illustrative diagram. FIG. 6A shows developer/reviewer 608 may view, using a spatial computing device, source code rendering interface 602. Source code rendering interface may display one or more source code elements. Source code rendering interface may display token 1, shown at 604 and token 2, shown at 606. Token 1 may be linked, using unit logic 1, shown at 610, to developer 1, shown at 612. Token 2 may be linked, using unit logic 2, shown at 614, to developer 2, shown at 616. Token 1 may have been created by developer 1. Token 2 may have been created by developer 2.

FIG. 6B shows source code rendering interface 602. In FIG. 6B, details and source code included in token 1 and token 2 are shown.

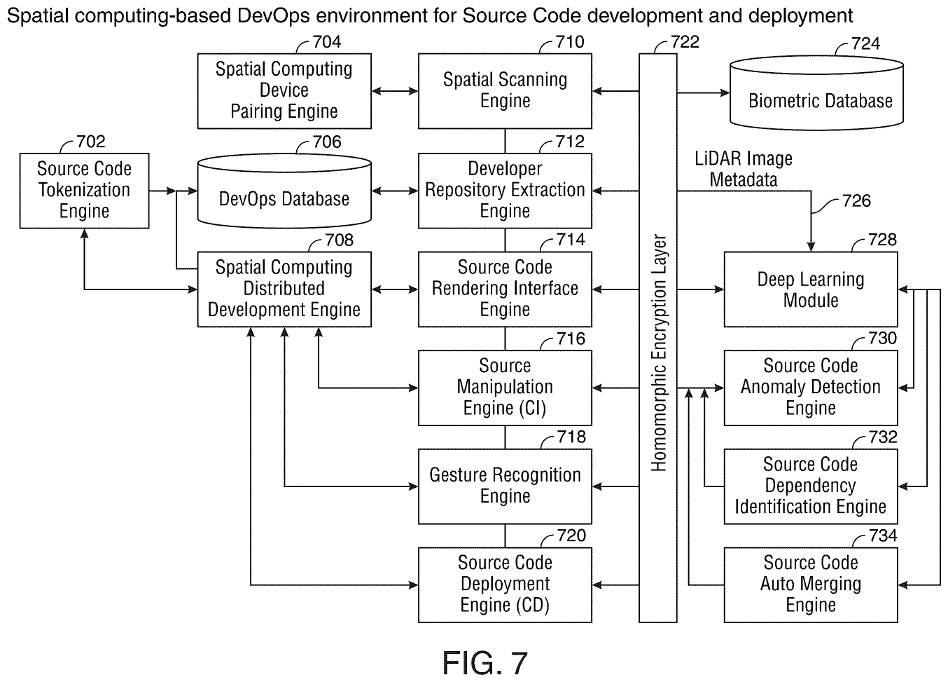

FIG. 7 shows an illustrative flow chart. Source code tokenization engine 702 may tokenize stored source code elements into components. The components may be divided based on the creator of the source code elements. As such, each token may be associated with a single developer. At times, each token may be associated with one or more developers.

The source code elements may be stored at DevOps database 706. As such, source code tokenization engine 702 may interface with DevOps database 706 to tokenize the source code elements.

Source code tokenization engine 702 may also interface with spatial computing distributed development engine 708. Spatial computing distributed development engine 708 may enable multiple spatial computing devices to operate within a distributed environment. Spatial computing distributed development engine 708 may orchestrate activities within the spatial computing environment. Spatial computing distributed development engine 708 may also ensure that the source code created by the developers is stored within DevOps database 706.

Spatial computing device pairing engine 704 may link two or more spatial computing devices. Spatial scanning engine 710 may scan a developer wearing a spatial computing device. Spatial scanning engine 710 may scan the developer for facial biometric data, such as iris data, fingerprint data or any other suitable data. Based on the scanned biometric data, spatial scanning engine 710 may compare the scanned biometric data to stored biometric data. The stored biometric data may be stored within biometric database 724. Biometric database 724 may be hosted by a third-party. As such, the biometric authentication may be processed by a third-party biometric authentication engine.

When a first developer identifies a second developer using a spatial computing device, developer repository extraction engine 712 may extract the source code from the repository. The source code may be linked to the second developer. The source code may have been created by the second developer.

Source code rendering interface engine 714 may provide an interface for the first developer to view the extracted source code. The first developer may be able to view multiple source code elements on a spatial computing device, which may be rendered by Source code rendering interface engine 714.

Source code manipulation engine 716 may enable the first developer to manipulate the displayed source code. As such, the first developer may modify the displayed source code and/or provide comments to the displayed source code.

A developer may be able to control which other developers may manipulate source code a developer has written. A developer operating on the source code, such as branching, merging or scanning the source code, may be done via gesture. Gesture recognition engine 718 may define which gestures can be applied. Gestures may include swipe operations, pinch operations or any other suitable gestures. Gesture recognition engine 718 may translate the gestures into computer operations. For example, a swipe may be identified by gesture recognition engine 718 as a code commit. In another example, a swipe may be interpreted by gesture recognition engine 718 as an instruction to generate a token for a code commit.

Source code deployment engine 720 may enable the first developer to deploy one or more source code elements. The source code elements may be displayed at the interface. The source code elements may be deployed within a production environment.

Homomorphic Encryption Layer 722 may be used to encrypt sensitive data. The encryption may protect the acquired biometric data, such as iris and fingerprint data. Additionally, the system may understand the style of a developer and include tokens to store the style of the developer. Such tokens may also be referred to as sensitive data. Homomorphic Encryption Layer 722 may maintain the privacy of a developer. This is specifically useful in a distributed development environment where various developers are located at various locations and may be vulnerable to one or more malicious attempts. As such, there is no decryption taking place within the system, and preferably all activities are being executed within the encrypted layer.

Deep learning module 728 using LiDAR Image metadata 726 may provide artificial intelligence to source code anomaly detection engine 703, source code dependency identification engine 732 and source code auto merging engine 734. LiDAR Image metadata 726 may be leveraged to enable determining ranges by targeting an object or surface with a laser and measuring the time for the reflected light to return to the receiver.

Source Code Anomaly Detection Engine 730 may detect anomalies in source code.

Source Code Dependency Identification Engine 732 may detect dependencies within the source code. For example, if a first source code element is conditional on a second source code element, the first source code element may be termed as dependent on the second source code element. Dependencies may also include a source code element that is dependent on a library or code snippet. The Source Code Dependency Identification Engine 732 may determine that the linkage between the source code and the library is a proper linkage.

Source Code Auto Merging Engine 734 may be used to merge two or more source code elements. Source Code Auto Merging Engine 734 may merge the two or more source code elements in a logical way to ensure efficient linkage. For example, a first source code element is 1000 lines, and a second source code element is 500 lines, and a third source code element is using the first source code element and the second source code element.

Source Code Auto Merging Engine 734 may identify the similarities and differences between the first source code element and the second source code element in order to ensure that the code repository does not include redundant code.

Thus, methods and apparatus for a SPATIAL COMPUTING SOURCE CODE DEVELOPMENT SECURITY SYSTEM are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A spatial computing-based distributed development and deployment environment, the environment comprising:
a plurality of spatial computing devices operated by a plurality of developers;
each of the spatial computing devices comprising a field of view, said field of view displaying one or more developers operating on one or more spatial computing devices included in the plurality of developers;
each of the spatial computing devices operable to extract facial biometrics from one or more developers displayed within the field of view;
each of the spatial computing devices operable to communicate the extracted facial biometrics with a development platform;
a development platform, the development platform is operable to:
validate the extracted facial biometrics;
identify an authenticated developer associated with the extracted facial biometrics; and
retrieve one or more source code elements associated with the authenticated developer;
a source code rendering interface, the source code rendering interface operating on each of the spatial computing devices, the source code rendering interface operable to render the retrieved one or more source code elements.

2. The environment of claim 1, wherein at least two of the plurality of spatial computing devices are located in different physical locations.

3. The environment of claim 1, wherein each of the spatial computing devices is operable to input one or more approvals and/or modifications to the one or more source code elements.

4. The environment of claim 1, wherein each of the spatial computing devices is operable to deploy approved source code elements.

5. A spatial computing-based distributed development and deployment environment, the environment comprising:
a plurality of spatial computing devices operated by a plurality of developers;
a virtual development database, said virtual development database storing source code created by the plurality of developers using the plurality of spatial computing devices;
a source code tokenization engine operating within the virtual development database, the source code tokenization engine tokenizes source code, stored within the virtual development database, into source code tokens, each source code token is created by an individual developer included in the plurality of developers;
a spatial computing device pairing engine operating on one or more spatial computing devices included in the plurality of spatial computing devices, the spatial computing device pairing engine pairs two or more spatial computing devices;
a spatial computing distributed development engine operating on one or more spatial computing devices included in the plurality of spatial computing devices and the virtual development database, the spatial computing distributed development engine verifies that source code created on the one or more spatial computing devices is stored within the virtual development database;
a spatial scanning engine operating on one or more spatial computing devices included in the plurality of spatial computing devices, the spatial scanning engine enables a first spatial computing device, included in the plurality of spatial computing devices, to scan a second developer wearing a second spatial computing device, the scan retrieves facial biometric data from the second developer;
a developer repository extraction engine, upon identification of the second developer, the developer repository extraction engine extracts source code tokens, from the database, created by the second developer;
a source code rendering interface engine, wherein, upon extraction of the source code tokens, the source code rendering interface engine renders the source code tokens on a display interface of the second spatial computing device;
a source code manipulation engine, said source code manipulation engine receives input relating to manipulating the source code tokens displayed on the first spatial computing device;
a gesture recognition engine, the gesture recognition engine translates gestures, received from a developer operating the first spatial computing device, into computer operations, said computer operations being used to manipulate the source code tokens displayed on the first spatial computing device;
a source code deployment engine, the source code deployment engine deploys the source code tokens displayed on the first spatial computing device;
a biometric database, the biometric database stores facial biometric data relating to the plurality of developers;
a source code anomaly detection engine, said source code anomaly detection engine detects anomalies in the source code tokens;
a source code dependency identification engine, said source code dependency identification engine detects dependencies between source code elements;
a source code auto-merging engine, said source code auto-merging engine merges two or more source code elements;
a deep learning module, said deep learning module provides artificial intelligence to the source code anomaly detection engine, the source code dependency identification engine and the source code auto-merging engine; and
a homomorphic encryption layer, said homomorphic encryption layer operable to:
interface between the spatial scanning engine, the developer repository extraction engine, the source code rendering interface engine, the source code manipulation engine, the gesture recognition engine, the source code deployment engine and the biometric database, the deep learning module, the source code anomaly detection engine, the source code dependency identification engine and the source code auto-merging engine; and
preserve privacy of data included in the biometric database, deep learning module, source code anomaly detection engine, source code dependency identification engine and source code auto-merging engine.

6. The environment of claim 5, wherein at least two of the spatial computing devices included in the plurality of spatial computing devices are located in different physical locations.

7. The environment of claim 5, wherein the source code deployment engine deploys the source code tokens displayed on the first spatial computing device by committing the source code tokens to a production environment.

8. The environment of claim 5, wherein the developer repository extraction engine identifies the second developer by comparing the retrieved facial biometric data to stored biometric data within the biometric database.

9. The environment of claim 5, wherein when the source code anomaly detection engine detects one or more anomalies the source code tokens, the source code anomaly detection engine prevents the source code deployment engine from deploying the source code tokens that included the source code anomalies.

10. The environment of claim 5, wherein:
when the source code anomaly detection engine detects one or more anomalies within the source code tokens, the source code anomaly detection engine communicates with the source code dependency identification engine to detect one or more dependencies between the source code tokens with the detected anomalies and one or more other source code tokens; and
the source code anomaly detection engine quarantines the source code tokens with the detected anomalies and the one or more other source code tokens.

11. The environment of claim 5, wherein:
when the source code anomaly detection engine detects one or more anomalies within the source code tokens, the source code anomaly detection engine communicates with the source code dependency identification engine to detect one or more dependencies between the source code tokens with the detected anomalies and one or more other source code tokens; and
the source code anomaly detection engine prevents the source code deployment engine from deploying the source code tokens with the detected anomalies and the one or more other source code tokens.

12. A method for securing a spatial computing distributed development and deployment environment, the method comprising:
identifying, by a first developer operating a first spatial computing device, the presence of one or more other developers operating one or more other spatial computing devices within a field of view of the first developer within the environment;
extracting, by the first spatial computing device, biometric data from each of the one or more other developers;
determining, by the first spatial computing device, an identity of the one or more developers by comparing the extracted biometric data to stored biometric data within a biometric database;
retrieving, by the first spatial computing device, one or more source code tokens created by the one or more developers; and
rendering, at the first spatial computing device, the retrieved one or more source code tokens.

13. The method of claim 12, further comprising manipulating, at the first spatial computing device, the one or more source code tokens.

14. The method of claim 13, wherein the manipulating is executed by receiving one or more gestures from the first developer via the first spatial computing device.

15. The method of claim 12, further comprising detecting, at the first spatial computing device, anomalies within the one or more source code tokens.

16. The method of claim 15, further comprising quarantining the one or more source code tokens that include anomalies.

17. The method of claim 16, further comprising preventing deploying of the quarantined source code tokens.
